(19) United States
(12) Patent Application Publication
(10) Pub. No.: US 2018/0287463 A1
(43) Pub. Date: Oct. 4, 2018

(54) ROTARY ELECTRIC MACHINE

(71) Applicant: MITSUBISHI ELECTRIC CORPORATION, Chiyoda-ku, Tokyo (JP)

(72) Inventors: Koji KAWASHIMA, Tokyo (JP); Fumio MATSUMOTO, Tokyo (JP)

(73) Assignee: MITSUBISHI ELECTRIC CORPORATION, Chiyoda-ku, Tokyo (JP)

(21) Appl. No.: 15/754,320

(22) PCT Filed: Aug. 31, 2015
(86) PCT No.: PCT/JP2015/074592

§ 371 Date: Feb. 22, 2018

(51) Int. Cl. H02K 9/08; H02K 5/20; H02K 9/10

(52) U.S. Cl. CPC H02K 9/08; H02K 9/10; H02K 5/20

(57) ABSTRACT

In a rotary electric machine having a cooling structure for cooling a stator and a rotor by circulating a cooling gas, a gas cooling unit is disposed above, below, or beside the side surface of a casing in which the stator and the rotor are accommodated and a heat insulating unit for preventing transfer of heat is provided between a low temperature cooling gas flow path in the gas cooling unit and the casing.

### TECHNICAL FIELD

The present invention relates to a rotary electric machine and, more particularly, to a rotary electric machine having a cooling structure for cooling a stator and a rotor by circulating a cooling gas.

### BACKGROUND ART

In a rotary electric machine having a cooling structure for cooling a stator and a rotor by circulating a cooling gas such as air or a hydrogen gas, the stator and the rotor are accommodated in a casing, a cooling gas is supplied to cooling gas flow paths provided in the rotor and the stator from the cooling gas inflow ports provided at both ends of a rotary shaft to cool the rotor and the stator, the cooling gas is cooled by a gas cooling unit, and the cooling gas is circulated to cool the rotor and the stator again.

In the rotary electric machine using the cooling gas, the cooling gas circulated by a fan is evenly blown to get the most of the cooling performance of the gas cooling unit (PTL

Particularly in the rotary electric machine disclosed in PTL 1, gas cooling units are distributed in four positions on both side surfaces at both ends of the rotary shaft of the rotor to balance the state of cooling by a cooling gas.

### CITATION LIST

### Patent Literature

PTL 1: Japanese Patent No. 5388961

### SUMMARY OF INVENTION

### Technical Problem

When a plurality of gas cooling units is distributed to get the most of the cooling performance of the gas cooling units, connection between the gas cooling units and gas circulation paths becomes complicated. In addition, since the size of the entire rotary electric machine is increased by the outer dimensions of the gas cooling units, the flexibility of installation is reduced. In particular, when the gas cooling units are disposed on both side surfaces of the rotary electric machine, since the gas cooling units disposed on the side surfaces of the rotary electric machine project, a wide installation area is necessary.

That is, although a large gas cooling unit having additional cooling performance can be provided when the installation area is sufficient, an object of the invention is to improve the flexibility of installation of the rotary electric machine by obtaining sufficient cooling performance using the minimum volume.

### Solution to Problem

A rotary electric machine according to the invention includes a casing in which a stator and a rotor are accommodated, a gas cooling unit including intake ports for a cooling gas provided on both ends and communicating with the casing, a high temperature cooling gas flow path through which the cooling gas at high temperature sucked from the intake ports passes, a ventilation surface exchanging heat with the cooling gas at high temperature and cooling the cooling gas, a low temperature cooling gas flow path through which the cooling gas having passed through the ventilation surface passes, and exhaust ports for the cooling gas which are provided at both ends and through which the cooling gas at low temperature in the low temperature cooling gas flow path flows to the casing, in which the ventilation surface is disposed above, below, or beside a side surface of the casing so as to be parallel to a rotary shaft of the rotor, a gas cooling unit disposed so that the high temperature cooling gas flow path is away from the casing and the low temperature cooling gas flow path is close to the casing, and a heat insulating unit provided between the low temperature cooling gas flow path of the gas cooling unit and the casing, the heat insulating unit preventing transfer of heat between the low temperature cooling gas flow path and the casing.

### Advantageous Effects of Invention

According to the invention, since the cooling efficiency of gas cooling units can be improved, the number of gas cooling units to be installed can be minimized, the rotary electric machine having a minimum installation area can be achieved, and the flexibility of installation can be increased.

### BRIEF DESCRIPTION OF DRAWINGS

FIG. 1 is a schematic cross sectional view illustrating embodiment 1 of the invention.

FIG. 2 is a schematic cross sectional view taken along line A-A in FIG. 1.

FIG. 3 is a schematic cross sectional view illustrating embodiment 2 of the invention.

FIG. 4 is a schematic cross sectional view taken along line B-B in FIG. 3.

FIG. 5 is a schematic cross sectional view illustrating embodiment 3 of the invention.

FIG. 6 is a schematic cross sectional view taken along line B-B in FIG. 5.

FIG. 7 is a schematic cross sectional view illustrating an example of embodiment 4 of the invention.

FIG. 8 is a schematic cross sectional view seen from line B-B in FIG. 7.

FIG. 9 is a schematic cross sectional view illustrating an example of embodiment 4 of the invention.

FIG. 10 is a schematic cross sectional view illustrating an example of embodiment 4 of the invention.

### DESCRIPTION OF EMBODIMENTS

### Embodiment 1

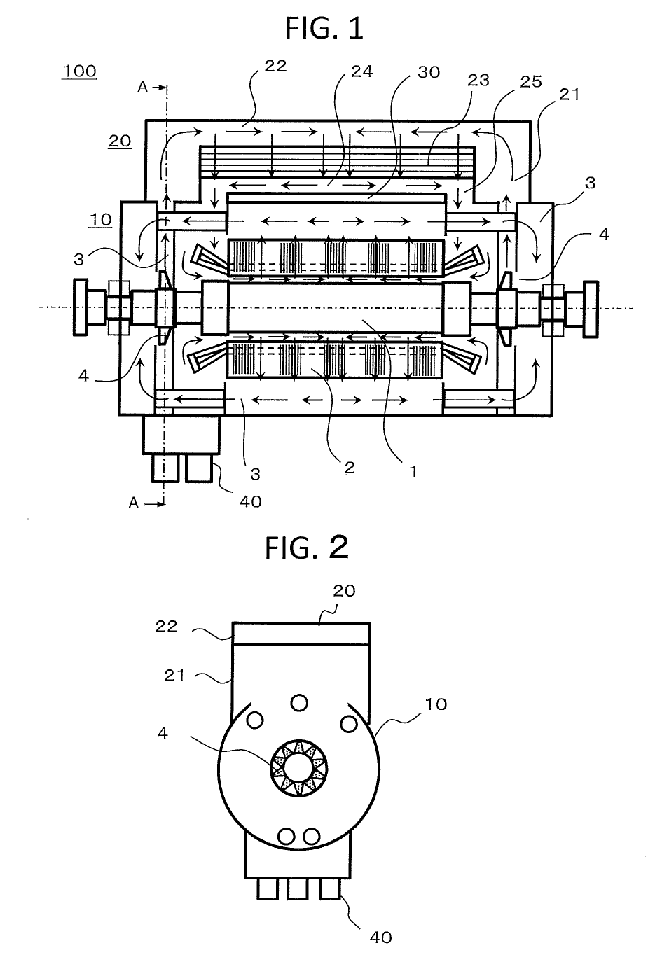

An embodiment of the invention will be described below with reference to the drawings. As illustrated in FIG. 1, a rotary electric machine 100 is configured as an integrated structure including a casing 10 in which a rotor 1 and a stator 2 are accommodated and a gas cooling unit 20 for cooling the cooling gas in the casing 10. A pipe for supplying the cooling gas is not present between the casing 10 and the gas cooling unit 20 and the gas cooling unit 20 is integrally attached to the casing 10. The rotor 1 and the stator 2 are cooled by directly receiving the cooling gas cooled by the gas cooling unit 20 into the casing 10. In the casing 10, there is a cooling gas flow path 3 having a complicated structure through which the cooling gas circulates. As the cooling gas flow path 3, the duct between the rotor 1 and the stator 2 and the duct (not illustrated) of the stator 2 are used to cool the rotor 1 and the stator 2. The cooling gas circulates as a fan 4 provided in the rotor 1 rotates, flows through the cooling gas flow path 3 as illustrated arrows in the drawing to cool the rotor 1 and the stator 2, returns to the gas cooling unit 20, is cooled again by the gas cooling unit 20, and returns to the casing 10.

As illustrated in FIG. 1, the gas cooling unit 20 includes cooling gas intake ports 21 communicating with the casing 10 at both ends, a high temperature cooling gas flow path 22 through which the cooling gas at high temperature sucked from the intake ports 21 flows, a ventilation surface 23 exchanging heat with the cooling gas at high temperature and cooling the cooling gas, a low temperature cooling gas flow path 24 through which the cooling gas having passed through the ventilation surface 23 passes, exhaust ports 25, provided at both ends, through which the cooling gas at low temperature in the low temperature cooling gas flow path 24 flows to the casing.

In embodiment 1, the gas cooling unit 20 is mounted above the side surface of the casing 10. In particular, the ventilation surface 23 of the gas cooling unit 20 is disposed in parallel to the rotary shaft of the rotor 1 so that the high temperature cooling gas flow path 22 is away from the casing 10 and the low temperature cooling gas flow path 24 is close to the casing 10. In such a structure, since the temperature of the wall surface of the casing 10 is increased by the cooling gas having cooled the stator 2, it is necessary to prevent the temperature of the low temperature cooling gas flow path 24 from being increased by heat of the outer wall of the casing 10. Accordingly, a heat insulating unit 30 is provided between the casing 10 and the gas cooling unit 20 to prevent heat from being transferred from the casing 10 to the gas cooling unit 20. In embodiment 1, the heat insulating unit 30 is a space. The heat insulating unit 30 is an encapsulated space communicating with no other spaces and the gas hermetically sealed in this space prevents heat from being transferred. In addition, the effect can be further improved by filling the heat insulating unit 30 with a heat insulating material or a liquid such as heat insulating oil and sealing the heat insulating unit 30 so that the heat transfer is further prevented.

FIG. 2 schematically illustrates a cross section taken along line A-A in FIG. 1. This cross sectional view indicates the part from the fan 4 to the intake ports 21 of the gas cooling unit 20 and the entry of the high temperature cooling gas flow path 22 among flow paths for the cooling gas circulated by the fan 4. In addition, the gas cooling unit 20 is provided above the casing 10 and a main lead 40 is provided below the casing 10. That is, the main lead 40 for transmitting and receiving electric power and the gas cooling unit 20 are provided axisymmetrically with respect to the rotary shaft of the rotor 1 and, when the main lead 40 is drawn downward from the casing 10, the gas cooling unit 20 is provided above the casing 10.

If the gas cooling unit 20 is disposed above the casing 10 and the main lead 40 is disposed below the casing 10 as described above, the installation area of the rotary electric machine 100 can be reduced and the flexibility of disposition of the rotary electric machine 100 can be increased.

### Embodiment 2

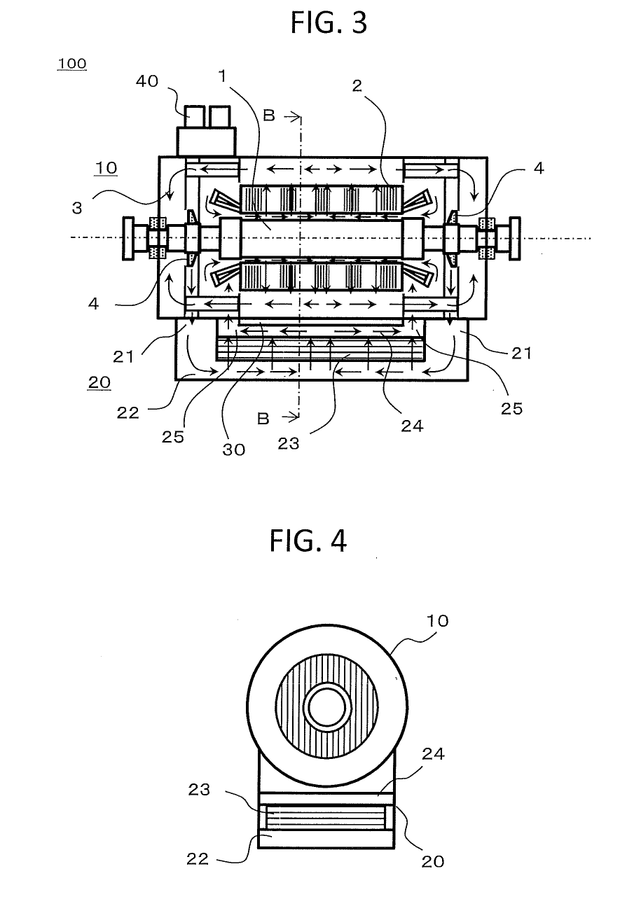

In embodiment 1, the main lead 40 of the rotary electric machine 100 is drawn downward from the casing 10. However, the direction in which the main lead 40 is drawn is not limited to the downward direction of the casing 10 and, depending on the disposition of the rotary electric machine 100, the main lead 40 may be drawn upward from the casing 10. In this case, the gas cooling unit 20 is disposed below the casing as illustrated in FIG. 3. That is, the main lead 40 for transmitting and receiving electric power and the gas cooling unit 20 are disposed axisymmetrically with respect to the rotary shaft of the rotor 1 and, when the main lead 40 is drawn upward from the casing 10, the gas cooling unit 20 is disposed below the casing 10.

When the gas cooling unit 10 is disposed below the casing 10 as described above, there is an advantage in that the maintenance of the main lead 40 is easy. In addition, the installation area can be reduced as described in embodiment 1.

FIG. 4 schematically illustrates a cross section taken along line B-B in FIG. 3. Although the main lead 40 is not indicated in this drawing, the gas cooling unit 20 is disposed below the casing 10.

### Embodiment 3

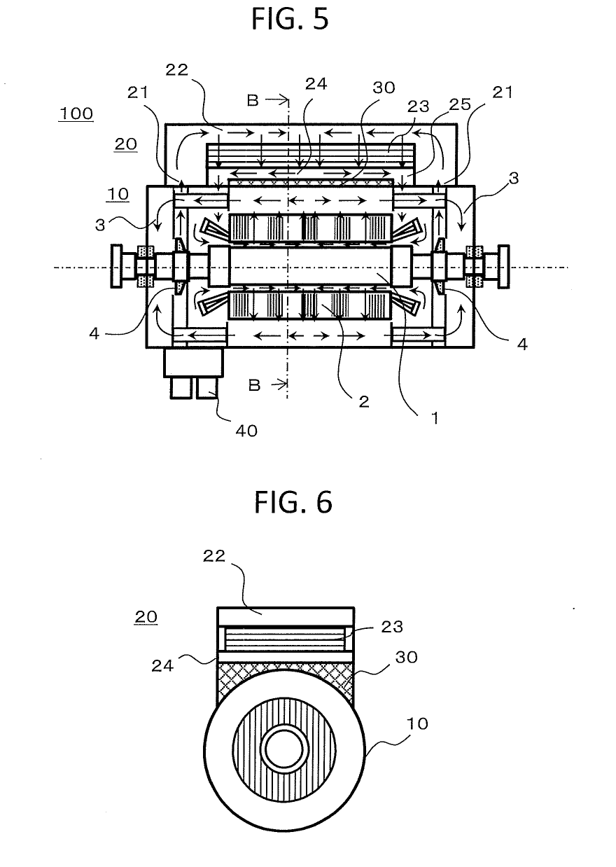

In embodiments 1 and 2, a space is provided as the heat insulating unit 30 and a gas is encapsulated in the space as needed. In embodiment 3, another member is used as the heat insulating unit 30. That is, FIGS. 5 and 6 illustrate the rotary electric machine 100 in which the space is filled with a heat insulating material as the heat insulating unit 30 for preventing heat conduction between the casing 10 and the gas cooling unit 20. When the space is filled with a heat insulating material as the heat insulating unit 30 as illustrated in FIGS. 5 and 6, there is an advantage in that maintenance is easy.

### Embodiment 4

In embodiments 1 to 3, a space is provided as the heat insulating unit 30 and a heat insulating gas or a heat insulating material is encapsulated in the space. However, the same effects can be also obtained by providing a heat insulating member on the inner wall surface of the casing 10 or the inner wall surface of the low temperature cooling gas flow path 24 of the gas cooling unit 20 without providing a space.

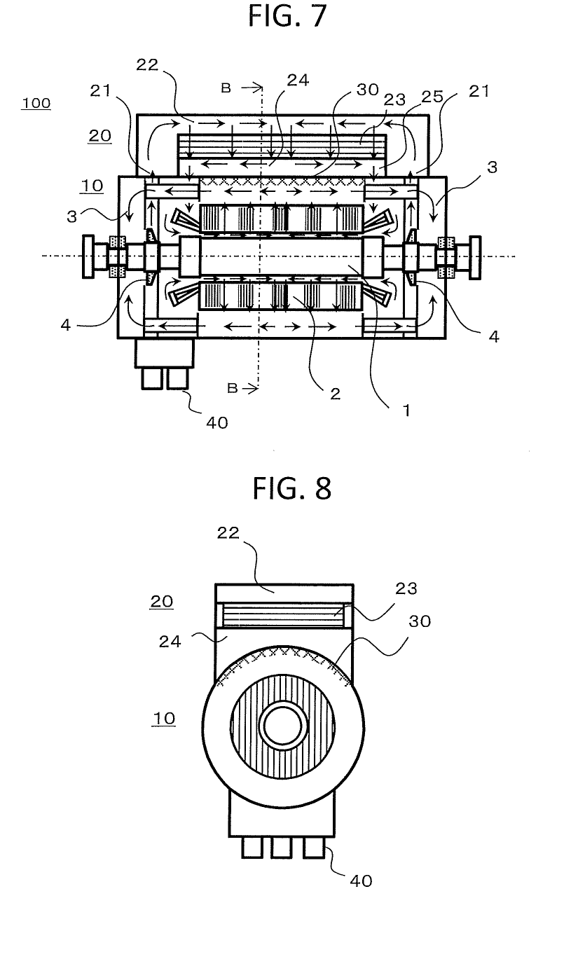

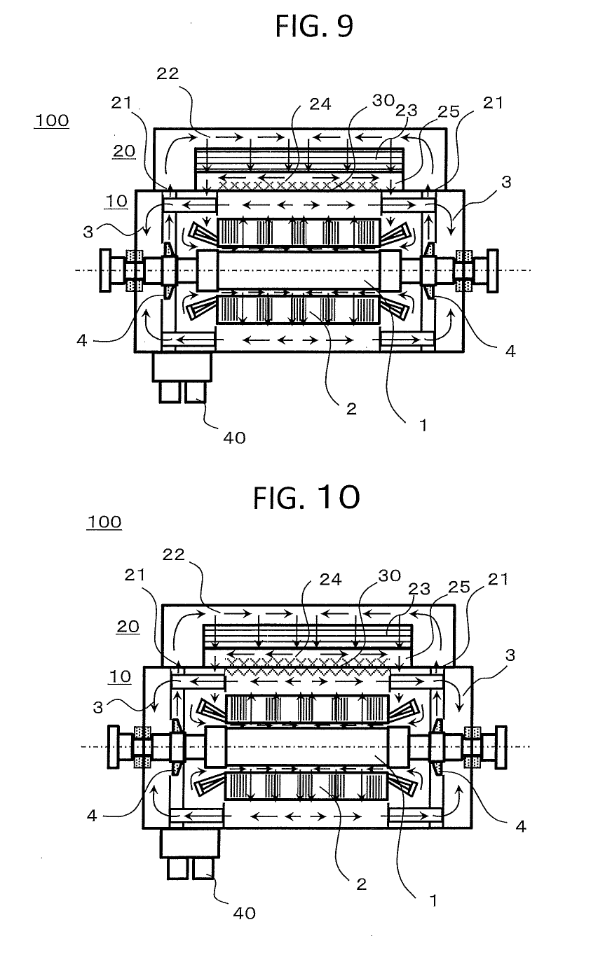

That is, as illustrated in FIGS. 7 and 8, a heat insulating member may be pasted as the heat insulating unit 30 on the wall surface of the casing 10. Alternatively, as illustrated in FIG. 9, a heat insulating member may be pasted on the inner, wall surface of the gas cooling unit 20 close to the casing 10. In addition, as illustrated in FIG. 10, it is possible to prevent transfer of heat between the cooling gas flowing through the casing 10 and the cooling gas flowing through the gas cooling unit 20 by providing heat insulating members on the inner wall surfaces of both the casing 10 and the gas cooling unit 20 to configure the heat insulating unit 30.

Although the case in which the ventilation surface of the gas cooling unit is provided above the side surface of the casing and the case in which the ventilation surface of the gas cooling unit is provided below the side surface of the casing have been specifically described in the embodiments of the invention, needless to say particularly, the ventilation surface of the gas cooling unit may be provided in one position beside the side surface of the casing so as to be parallel to the rotary shaft of the rotor of the rotary electric machine as another embodiment of the invention. In the invention, the embodiments may be combined arbitrarily or the embodiments may be modified or omitted as appropriate within the scope of the invention.

1. A rotary electric machine comprising:
a casing in which a stator and a rotor are accommodated;
a gas cooling unit including
intake ports for a cooling gas provided on both ends and communicating with the casing,
a high temperature cooling gas flow path through which the cooling gas at high temperature sucked from the intake ports passes,
a ventilation surface exchanging heat with the cooling gas at high temperature and cooling the cooling gas,
a low temperature cooling gas flow path through which the cooling gas having passed through the ventilation surface passes, and
exhaust ports for the cooling gas which are provided at both ends and through which the cooling gas at low temperature in the low temperature cooling gas flow path flows to the casing, wherein the ventilation surface is disposed above, below, or beside a side surface of the casing so as to be parallel to a rotary shaft of the rotor;
a gas cooling unit disposed so that the high temperature cooling gas flow path is away from the casing and the low temperature cooling gas flow path is close to the casing; and
a heat insulating unit provided between the low temperature cooling gas flow path of the gas cooling unit and the casing, the heat insulating unit preventing transfer of heat between the low temperature cooling gas flow path and the casing.

2. The rotary electric machine according to claim 1, further comprising:
a main lead for transmitting and receiving electric power,
wherein the gas cooling unit and the main lead are provided axisymmetrically with respect to the rotary shaft of the rotor,
the main lead is disposed below the casing, and
the gas cooling unit is disposed above the casing.

3. The rotary electric machine according to claim 1, further comprising:
a main lead for transmitting and receiving electric power,
wherein the gas cooling unit and the main lead are provided axisymmetrically with respect to the rotary shaft of the rotor,
the main lead is disposed above the casing, and
the gas cooling unit is disposed below the casing.

4. The rotary electric machine according to claim 1,
wherein the heat insulating unit includes a space provided between the casing and the gas cooling unit and a heat insulating material filling the space.

5. The rotary electric machine according to claim 1,
wherein the heat insulating unit is configured by at least one of a heat insulating member provided on an inner wall surface of the casing and a heat insulating member provided on an inner surface of the gas cooling unit.
